(19) United States
(12) Patent Application Publication
(10) Pub. No.: US 2001/0056372 A1
(43) Pub. Date: Dec. 27, 2001

(54) Method of consumer product promotion over the internet using unique product package numbers

(76) Inventors: Alan Keith James Rogan, Alwoodley Leeds (GB); James D. Watkins, Ocala, FL (US)

Correspondence Address: NEEDLE & ROSENBERG, P.C., The Candler Building, Suite 1200, 127 Peachtree Street, N.E., Atlanta, GA, 30303-1811, US

(21) Appl. No.: 09/864,086

(22) Filed: May 23, 2001

Related U.S. Application Data
(60) Provisional application No. 60/206,573, filed on May 23, 2000.

(51) Int. Cl. G06F 17/60

(52) U.S. Cl. 705/14

(57) ABSTRACT

A method for consumer product promotion through the Internet. A consumer purchases a package containing a consumer product identified by a universal product code and having a package identification number unique to the package. The consumer can access to a Web site to play an Internet game offered therein upon presentation of the package identification number to the Web site if the package identification number satisfies the following two conditions: (1) the format of the package identification number matches a predetermined format, and (2) the package identification number has not been presented yet.

### CROSS-REFERENCE TO RELATED PATENT APPLICATION

This application claims the benefit, pursuant to 35 U.S.C. § 120, of provisional U.S. Patent Application Ser. No. 60/206,573, filed May 23, 2000 entitled “METHODS OF COMMERCIAL PROMOTIONS USING AN INTERNET GAME SCHEME HAVING UNIQUE PRODUCT PACKAGE NUMBERS.”

### BACKGROUND OF THE INVENTION

1. Field of the Invention

The present invention generally relates to consumer product promotion. More particularly, the present invention relates to methods and apparatus for consumer product promotion through the Internet using unique product package numbers.

2. Description of the Related Art

Success of many consumer products depends on a successful marketing strategy. A common marketing strategy is for manufacturers to offer discount coupons, either in electronic form or in traditional paper form, which often use a Universal Product Code (“UPC”) as an identification of a specific product and a particular manufacturer. One disadvantage of this approach is that the manufacturer who uses this marketing strategy has the administrative inconvenience and cost associated with preparing, distributing and collecting the coupons, which may negatively affect the desire of a manufacturer to utilize the marketing strategy. Moreover, burdens on consumers to collect, clip and properly use the coupons at the point of sale often limit the effectiveness of this approach.

With recent proliferation in personal computers, the availability of on-line services and the Internet, another marketing strategy is to use the Internet to provide a variety of Internet games, such as match games including Bingo and Keno, knowledge-based games such as spelling games, and skill-based games, to attract consumers and potential consumers for consumer products. Part or all of the universal product codes that designate these products and manufacturers may be used as Internet access passwords or keys. This marketing strategy provides a low cost promotion method and is capable of reaching consumers worldwide. However, because these passwords may be used repeatedly by a consumer, who may just purchase one product to gain access to the Internet game, a merchant may not achieve the full potential of the promotion by using this strategy.

Therefore, there exists a need for methods and system for consumer product promotion through the Internet that not only are attractive to consumers and potential consumers but may generate sales of a product as well.

### SUMMARY OF THE INVENTION

The present invention provides methods and system for consumer product promotion through the Internet by offering an Internet game that offers prizes and is accessible by using a package identification number as a password, where the package identification number is uniquely associated with a package containing the consumer product and can only be used once to access the Internet game. By limiting the opportunity to play the Internet game to a consumer who has access to a package identification number that is valid for one entry only and offering the opportunity to win prizes by playing the Internet game, the consumer is encouraged to purchase more packages containing the consumer product and carrying the package identification numbers for more chances to play and win. Thus, the present invention generates brand loyalty in consumers and promotes the consumer product.

In one aspect of the present invention, a method for consumer product promotion through the Internet includes the steps of providing a plurality of packages each containing a consumer product identified by a universal product code to at least one consumer and establishing a package identification number having a predetermined format for each package, wherein the package identification numbers for the plurality of packages form a group of package identification numbers. The method further includes the steps of storing the package identification number for each package in a first database, establishing a cross-reference between the group of package identification numbers and the universal product code, storing the cross-reference between the group of package identification numbers and the universal product code in the first database, and employing a Web browser program to run a Web site that offers an Internet game, wherein the Web site is electronically coupled to the first database. The method permits access to the Internet game by the at least one consumer to play the Internet game upon presentation of a package identification number having the predetermined format over the Internet only if the package identification number has not been presented yet, and denies access to the Internet game by the at least one consumer to play the Internet game upon presentation of a package identification number having the predetermined over the Internet if the package identification number has been presented.

According to one embodiment of the invention, once the access to the Internet game is granted, the method includes the steps of employing the Web browser program to allow the at least one consumer to interactively play the Internet game, and rewarding the at least one consumer according to the outcome of the Internet game with one or more packages of the consumer product, one or more packages of other consumer products, or one or more opportunities to play the Internet game. If the access to the Internet game is denied, the method includes the steps of employing the Web browser program to allow the consumer to select another Internet-related activity other than the Internet game, and rewarding the consumer according to the outcome of the Internet-related activity with one or more packages of the consumer product, one or more packages of other consumer products, or one or more opportunities to play the Internet game.

In another aspect, the present invention relates to a method for consumer product promotion through the Internet. The method includes the steps of providing a package containing a consumer product identified by a universal product code to a consumer, establishing a package identification number having a predetermined format for the package, employing a Web browser program to run a Web site that offers an Internet game, and permitting access to the Internet game by the consumer to play the Internet game upon presentation of the package identification number over the Internet when the package identification number satisfies the following two conditions:

(i) the format of the package identification number matches a predetermined format, and

(ii) the package identification number has not been presented yet.

Moreover, the method includes the step of denying access to the Internet game by the consumer to play the Internet game upon presentation of the package identification number over the Internet when the package identification number satisfies at least one of the following two conditions:

(i) the format of the package identification number is not in match with the predetermined format; and

(ii) the package identification number has been presented.

In yet another aspect, the present invention relates to a system for consumer product promotion through the Internet, wherein the consumer product is identified by a universal product code and provided in a package to a consumer. In one embodiment, the system includes a number generator for establishing a package identification number having a format for the package, a memory device, and a processor coupled to the memory device and performing the following steps of employing a Web browser program to run a Web site that offers an Internet game, wherein the Web site is electronically coupled to the memory device, and permitting access to the Internet game by the consumer to play the Internet game upon presentation of the package identification number over the Internet when the package identification number satisfies the following two conditions:

(1) the format of the package identification number matches a predetermined format; and

(2) the package identification number has not been presented yet.

Additionally, the processor further performs the step of denying access to the Web site by the consumer to play the Internet game upon presentation of the package identification number over the Internet when the package identification number satisfies at least one of the following two conditions:

(1) the format of the package identification number is not in match with the predetermined format; and

(2) the package identification number has been presented.

The present invention further includes a computer program product in a computer readable medium of instructions. The computer program product has instructions within the computer readable medium for running a Web site that offers an Internet game. Furthermore, the computer program product has instructions within the computer readable medium for permitting access to the Internet game by a user to play the Internet game upon presentation of a package identification number over the Internet when the package identification number satisfies the following two conditions:

(1) the format of the package identification number matches a predetermined format; and

(2) the package identification number has not been presented yet, wherein the package identification number is associated with a package containing a consumer product identified by a universal product code.

Additionally, the computer program product includes instructions within the computer readable medium for denying access to the Internet game by the user to play the Internet game upon presentation of the package identification number over the Internet when the package identification number satisfies at least one of the following two conditions:

(i) the format of the package identification number is not in match with the predetermined format; and

(ii) the package identification number has been presented.

In one embodiment of the present invention, the consumer product is popcorn and the package containing popcorn is microwaveable. Alternatively, the consumer product can be other tangible products or even services that can be promoted by a brochure, for example. The package identification number is printed on the package and accessible by the consumer. Alternatively, the package identification number is printed on a printing medium that is associated with the package, where the printing medium can be a sticker or a label.

These and other aspects will become apparent from the following description of the preferred embodiment taken in conjunction with the following drawings, although variations and modifications may be effected without departing from the spirit and scope of the novel concepts of the disclosure.

### BRIEF DESCRIPTION OF THE DRAWINGS

FIG. 1 is a schematic representation of a system for the consumer product promotion over the Internet according to the present invention.

FIG. 2 is a schematic representation of a package having a PIN number and a UPC code that can be utilized in the inventive system shown in FIG. 1.

FIG. 3 is a flow chart showing one method for consumer product promotion over the Internet according to the present invention.

FIG. 4 is a flow chart showing a process related to the method as shown in FIG. 3.

FIG. 5 is a schematic representation of a Web site that can be utilized in the inventive system shown in FIG. 1.

FIG. 6 is a flow chart showing an alternative method for consumer product promotion over the Internet according to the present invention.

### DETAILED DESCRIPTION OF THE INVENTION

A preferred embodiment of the invention is now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

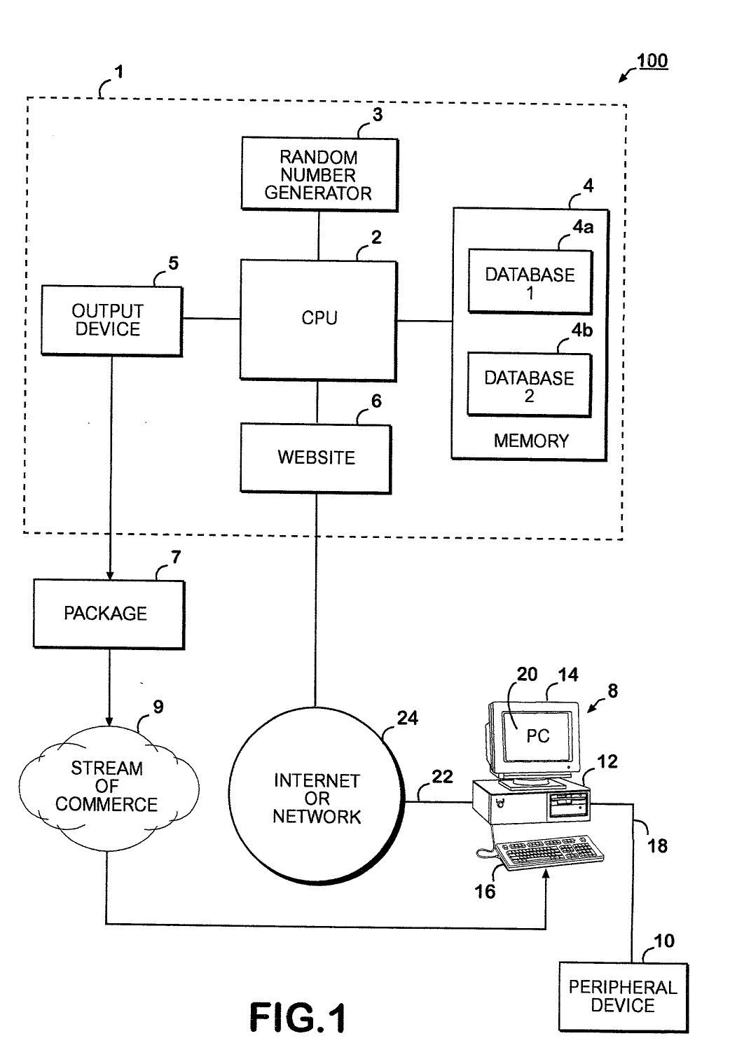

With reference to FIG. 1, the numeral 1 generally refers to a centralized processing system for the inventive method and system for consumer product promotion through the Internet. The centralized processing system 1 includes a processor or CPU 2 to which are connected to memory device 4 and output device 5. Additionally, CPU 2 has a random number generator 3 that can generate numbers randomly or pseudo-randomly. The memory device 4 has at least one database resident therein. In the embodiment as shown in FIG. 1, memory device 4 has a first database 4a and a second database 4b. Memory device 4 can have additional space. The output device 5 may include a printing device that can print a number generated by the random number generator 3 to a package 7. CPU 2 also employs a Web browser program to run a Web site 6 that, among other things, offers an Internet game.

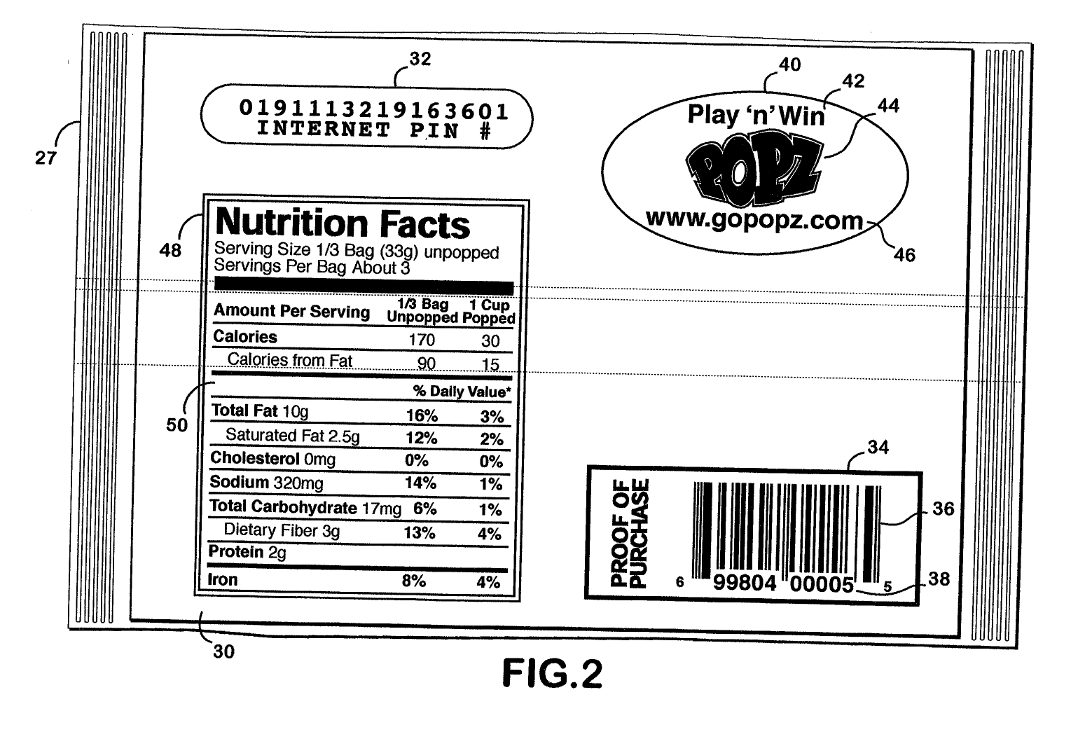

The package 7 contains at least one consumer product that is identified by a Universal Product Code (“UPC”). FIG. 2 shows an exemplary package 27 in a bag form that contains microwaveable popcorns manufactured by Soller Ltd., Bennettsville, S.C. 29512. Package 27 can be formed from paper stock, paperboard, plastics or like. On one side of the package 27, side 30, there are imprinted a package identification number 32 (“PIN”) unique to the package 27 and a UPC code 34. The PIN number 32 is generated by the random number generator 3. For security purposes, the PIN number 32 has at least 6 digits, preferably more than 10 digits, providing several billion possible code combinations. For the embodiment shown in FIG. 2, the PIN number 32 has 16 digits. The PIN number 32 can be directly imprinted to the package 27. Alternatively, the PIN number 32 may be imprinted on a printing medium, such as a sticker or a label, which then can be associated with the Package 27. The UPC code 34 contains a bar code portion 36 and a digital portion 38. Generally, UPC bar code is used to identify products for point of sale retail applications such as grocery and retail stores. UPC bar code includes 4 parts: the first number is the system identifier, next 5 digits are the manufacturers assigned number, next 5 digits are the manufacturer's own assigned product number and the last digit is the check digit. As an example, the digital portion 38 as shown in FIG. 2 has a combination (6 99804 00005 5).

The package 27 may have a marked portion 40 containing a promotion “Play ‘n’ Win” 42, a trademark POPZ 44 and an Internet IP address www.gopopz.com 46. The package 27 may also have a text portion 48 displaying Nutrition Facts 50. Other additional information in form of text, graphical or both can be displayed on the package 27 as well.

With proper identification and having product packed therein, package 7 enters the stream of commerce 9 to reach consumers. Once a consumer obtains a package 7, the consumer can then use the package identification number associated with the package 7 to access the Web site 6 through a communication network or Internet 24 from a terminal device or a computer 8.

In one embodiment of the present invention, computer 8 has a host processor 12 with a display 14, such as a monitor, having a graphic-user interface (GUI) 20 displaying data, text and graphic information and a key board receiving inputs from a user. The host processor 12 may have at least one peripheral device 10, shown here as a printer, in operative communication with the host processor 12. The printer 10 and host processor 12 can be in communication through any media, such as a direct wire connection 18, or through a network. The GUI 20 is generated by a GUI code as part of the operating system (O/S) of the host processor 12. The host processor 12 also is in communication with the Internet 24 through any media, such as a direct wire connection 22, or through another network.

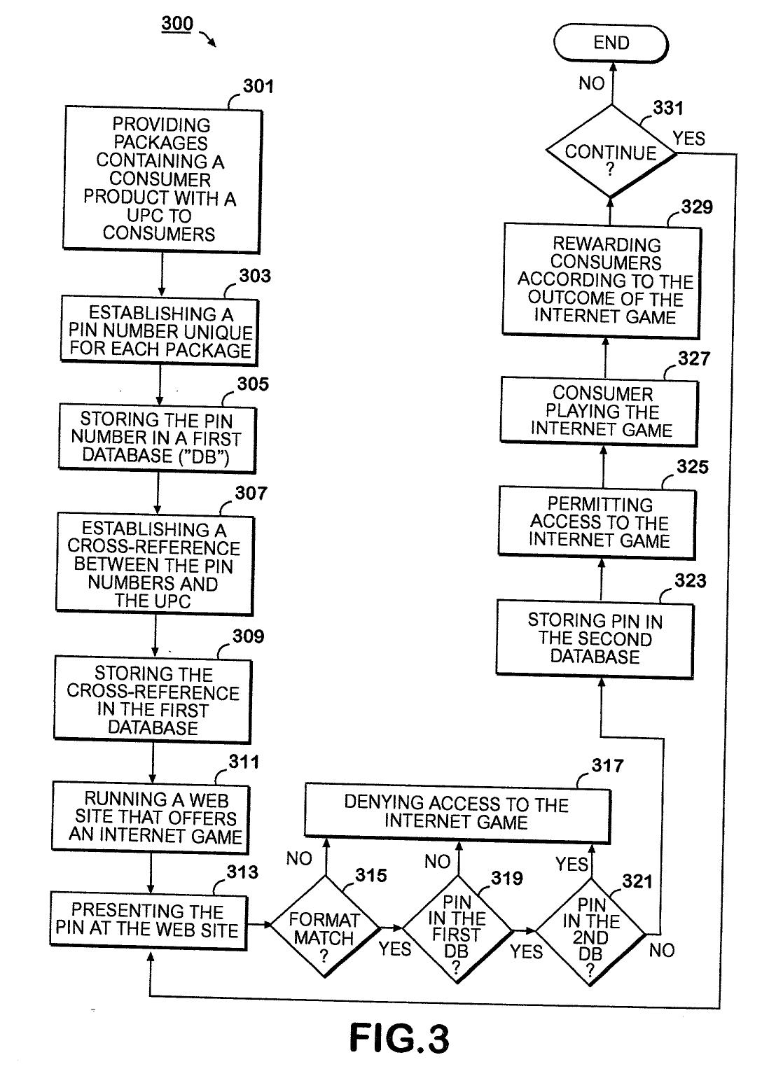

FIG. 3 shows a first embodiment method 300 of the present invention to utilize the inventive system 100 shown in FIG. 1 for consumer product promotion through the Internet. At step 301, a plurality of packages are provided with each containing a consumer product identified by a universal product code. At step 303, a package identification number (“PIN”) having a predetermined format is established for each package by the processing system 1, wherein the package identification numbers for the plurality of packages form a group of package identification numbers. The PIN number for each package can be generated by a random number generator 3, which is a program employed by the CPU 2. The predetermined format can be, for example, a sequence of randomly arranged Arabic numerals having a given length. In the embodiment shown in FIG. 2, the format of the PIN number 32 has 16 digits. Thus, for this embodiment, the predetermined format requires the PIN number to be a sequence of digits and to have 16 digits. Thus, combination (0191113219163601) has a format matching the predetermined format, and combination (0111856991), which only has a sequence of 10 digits, and combination (xyz1113219163601), which has a mix of alphabetic characters and Arabic numerals, do not have a format matching the predetermined format.

At step 305, the PIN number for each package is stored in a first database 4a, which is a program resident in memory 4. At step 307, a cross-reference between the group of PIN numbers for the packages and the universal product code for the consumer product is established, and then stored in the first database 4a at step 309, by the CPU 2. For example, for the package 27 shown in FIG. 2, it has a UPC code “6 99804 00005 5” for the microwave popcorns and a PIN number (0191113219163601) that has 16 digits. Thus, once the cross-reference between the group of PIN numbers for the packages 27 and the UPC code “6 99804 00005 5” for the microwave popcorns is established, any package from this manufacturer having a PIN number with 16 digits would contain the microwave popcorns. Consequently, the manufacturer may establish cross-references for each product and packages containing each product, which can be utilized for inventory control purpose and marketing purpose. For example, CPU 2 can simply count the number of access to the Web site 6 for a particular consumer product from the cross-references for the product and the PIN numbers for packages containing the product to assess the sales of the product in the market.

At step 311, a Web browser program is employed to run a Web site 6 that offers an Internet game, wherein the Web site 6 has an IP address and is electronically coupled to the memory 4. A consumer can access on the Web site 6 through an Internet service provider from the computer 8. In fact, the Web site 6 is running 24 hours a day, 365 days a year and can be reached by anyone around the World. On the Web site 6, several Internet activities are provided. As an embodiment shown in FIG. 5, a home page 500 for the Web site 6 has a Talent Show icon 501, Popcorn Watch icon 503, History of Popcorn 505, Ideas from the Top icon 507, POPZ Workshop icon 509, Ask Dr. Poppen icon 511, POPZ Shop icon 513, Product Info icon 515, Play the Popz Quiz 517, and Career Opportunities icon 519. Each icon represents an Internet related activity. At least one of them is an Internet game that may be interactively played by consumers. For the embodiment shown in FIG. 5, Play the Popz Quiz 517 is a game that may be interactively played by consumers. The Play the Popz Quiz game can take the form of a match game, a knowledge-based game, a skill-based game, any combination of them, or other types of available computer games. By clicking on each icon, a consumer can get information or interactively communicate with the Web site 6 in the form of sound, graphical, video, text, data, digital format, photo or a combination of them. Each icon may include more than one theme or sub-icons. For example, Talent Show icon 501 has a plurality of sub-icons including Submit Now icon 501a, Rules icon 501b, Winners icon 501c, and What Is the Talent Show icon 501d. More detailed information about each icon can be obtained from http://www.popz.com/, the information wherein is incorporated herein by reference each. Each icon and related contents can be updated from time to time.

Not every Internet activity offered on the Web site 6 can be freely accessed by a consumer. In particular, the present invention requires that the Internet game offered on the Web site 6 can only be accessed with a proper ID. Once the Internet game icon, i.e. icon 517 in the embodiment shown in FIG. 5, is clicked on, Web site 6 requires the consumer to present a package identification number or Internet PIN from a package containing the consumer product.

Referring back to FIG. 3, at step 313, a consumer now presents a package identification number at Web site 6. In operation, the consumer inputs the package identification number at the computer 8, which is transmitted through the Internet 24 to and received by the Web site 6. At step 315, CPU 2 determines if the presented package identification number has the predetermined format. An advantage of checking the format first is that it provides a quick screening without committing too much computing resources as a full search and comparison in a database as required in the prior art. If not, at step 317, the consumer is denied access to play the Internet game. If yes, at step 319, CPU 2 further determines if the package identification number exists in the first database. If not, the consumer is denied access to play the Internet game. This step ensures that a number not generated by and stored in the centralized system 1 but accidentally having a format matched with the predetermined format will not have access to the Internet game. If yes, at step 321, CPU 2 then determines if the package identification number exists in the second database. If yes, which indicates that the package identification number has been used before, the consumer is denied access to play the Internet game. This step ensures that the package identification number can only be used once to gain the access to play the Internet game. If the consumer wants to play the Internet game, he or she needs to have a new package identification number, which can be obtained from a package having the package identification number. The consumer is therefore encouraged to purchase more packages containing the consumer protect. If not, at step 323, CPU 2 stores the package identification number in the second database that only contains PIN numbers that have been presented or used. At step 325, the consumer is given access to the play the Internet game. At step 327, the consumer plays the Internet game interactively and when the game is over, an outcome is shown in the Web site 6. At step 329, CPU 2 rewards the consumer according to the outcome of the Internet game. The consumer may be rewarded with one or more packages of the consumer product for free, one or more packages of other consumer products for free, or one or more opportunities, i.e., free PIN numbers, to play the Internet game. Additionally, a consumer may be rewarded with other prizes including houses, automobiles, computers, CDs, holiday vacation packages, etc. to further encourage the consumer to purchase the consumer product so that the consumer has more chances to play and win. At step 331, the consumer has the option to continue to play the Internet game, which he or she will have access by presenting a new PIN number, or to stop.

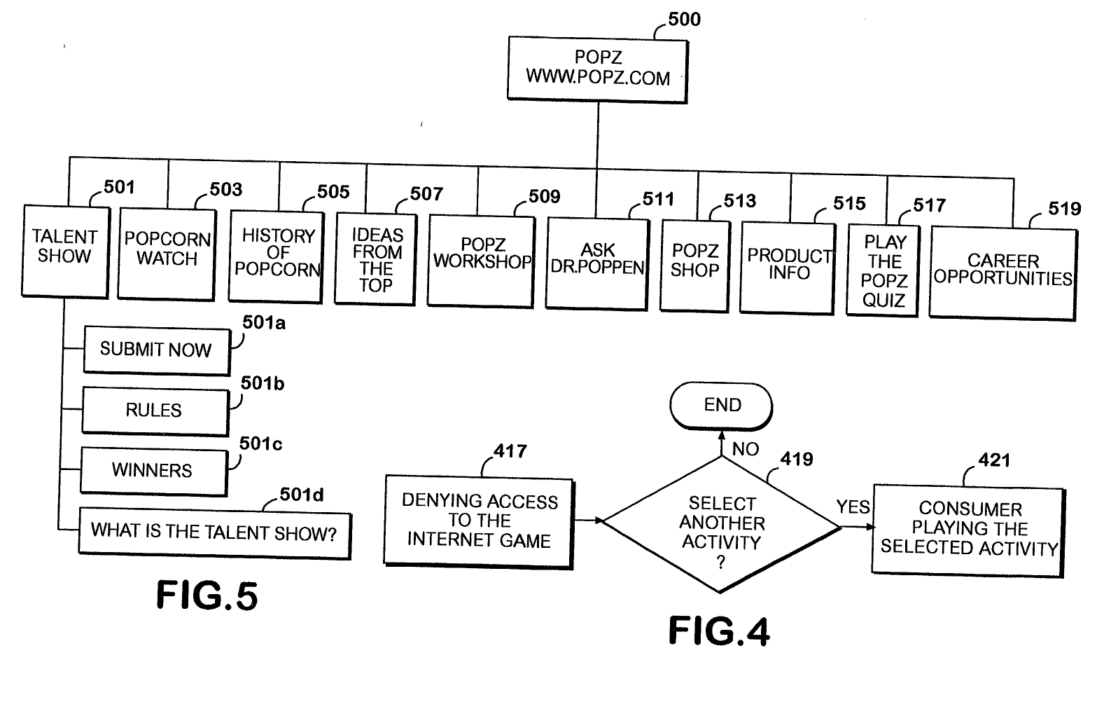

Referring now to FIG. 4, if the access to the Internet game is denied at step 417, a consumer is given a choice on the Web site 6 by CPU 2 to select another Internet-related activity other than the Internet game. If the consumer responds positively, at step 421, the consumer plays the Internet-related activity interactively. CPU 2 may reward the consumer according to the outcome of the Internet-related activity with one or more packages of the consumer product, one or more packages of other consumer products, or one or more opportunities, i.e., free PIN numbers, to play the Internet game. Occasionally, free PIN numbers may be offered in the Web site 6 to further encourage consumers to play the Internet game and thereby increase their interests in purchasing packages having the PIN numbers.

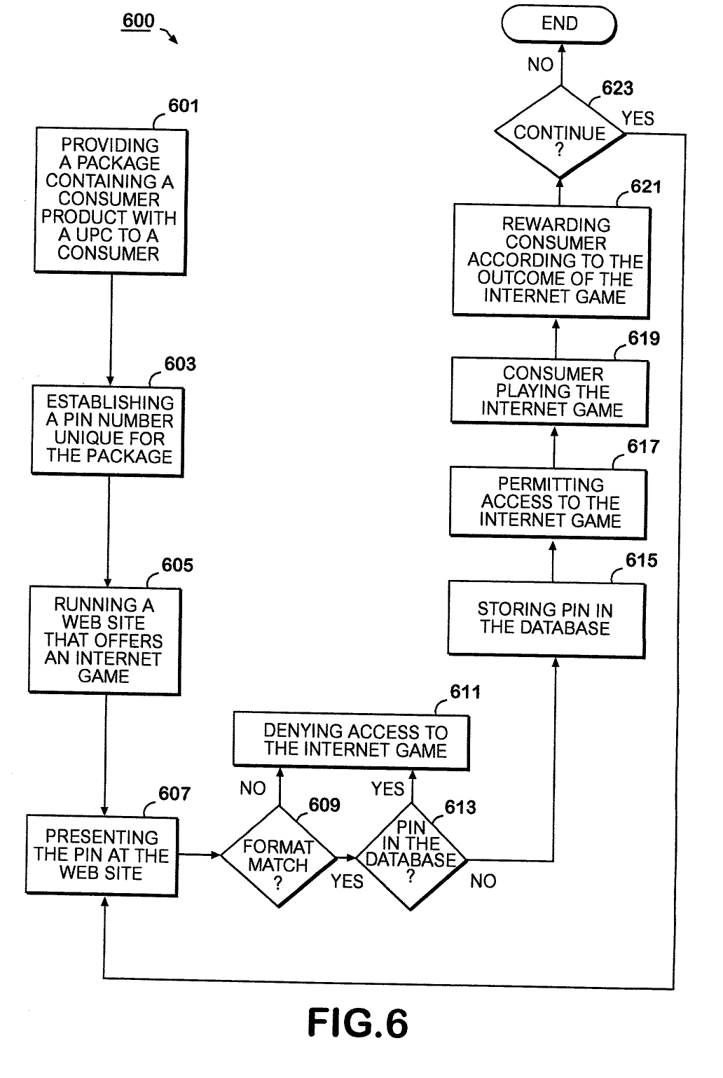

FIG. 6 shows another embodiment method 600 of the present invention to utilize the inventive system 100 shown in FIG. 1 for consumer product promotion through the Internet. At step 601, a package containing a consumer product identified by a universal product code is provided. At step 603, a package identification number (“PIN”) having a predetermined format is established for the package by the processing system 1. At step 605, a Web browser program is employed to run a Web site 6 that offers an Internet game. At step 607, a consumer presents a package identification number at Web site 6. At step 609, CPU 2 determines if the presented package identification number has the predetermined format. If not, at step 611, the consumer is denied access to play the Internet game. If yes, at step 613, CPU 2 further determines if the package identification number exists in a database resident in memory 4. If yes, which indicates that the package identification number has been used, the consumer is denied access to play the Internet game. If not, at step 615, CPU 2 stores the package identification number in the database. At step 617, the consumer is given access to the play the Internet game. At step 619, the consumer plays the Internet game interactively and when the game is over, an outcome is shown in the Web site 6. At step 621, CPU 2 rewards the consumer according to the outcome of the Internet game with various prizes as discussed before. At step 623, the consumer has the option to continue to play the Internet game, which he or she will have access by presenting a new PIN number, or to stop there.

Thus, for the embodiment shown in FIG. 6, CPU 2 permits access to the Internet game by a consumer to play the Internet game upon presentation of the package identification number over the Internet when the package identification number satisfies the following two conditions:

(1) the format of the package identification number matches a predetermined format; and

(2) the package identification number has not been presented.

Therefore, the Internet game may be played upon the presentation of a number that is not generated by the centralized processing system 1 but happens to have a format in match with the predetermined format. Even though, the number can only have one free pass to the Internet game. Nevertheless, this embodiment requires less computing power and memory space for processing and storing a huge database and responds to the consumers more promptly.

As those skilled in the art will appreciate, while the present invention has been described in the context of a fully functional centralized processing system interfacing with computers coupled through the Internet, the mechanism of the present invention is capable of being distributed in the form of a computer readable medium of instructions in a variety of forms, and the present invention applies equally regardless of the particular type of signal bearing media used to actually carry out the distribution. Examples of computer readable media include: recordable type media such as floppy disks and CD-ROMs and transmission type media such as digital, analog, optical and wireless communication links.

While there has been shown a preferred and alternate embodiments of the present invention, it is to be understood that certain changes can be made in the form and arrangement of the elements of the system and steps of the method as would be know to one a skill in the art without departing from the underlying scope of the invention as is particularly set forth in the claims. Furthermore, the embodiments described above are only intended to illustrate the principles of the present invention and are not intended to limit the claims to the disclosed elements.

What is claimed is:

1. A method for consumer product promotion through the Internet, comprising:
a. providing a plurality of packages each containing a consumer product identified by a universal product code to at least one consumer;
b. establishing a package identification number having a predetermined format for each package, wherein the package identification numbers for the plurality of packages form a group of package identification numbers;
c. storing the package identification number for each package in a first database;
d. storing establishing a cross-reference between the group of package identification numbers and the universal product code;
e. saving the cross-reference between the group of package identification numbers and the universal product code in the first database;
f. employing a Web browser program to run a Web site that offers an Internet game, wherein the Web site is electronically coupled to the first database;
g. permitting access to the Internet game by the at least one consumer to play the Internet game upon presentation of a package identification number having the predetermined format over the Internet only if the package identification number has not been presented yet; and
h. denying access to the Internet game by the at least one consumer to play the Internet game upon presentation of a package identification number having the predetermined over the Internet if the package identification number has been presented.

2. The method of claim 1, further comprising steps of:
a. employing the Web browser program to allow the at least one consumer to interactively play the Internet game once the access to the Internet game is granted; and
b. rewarding the at least one consumer according to the outcome of the Internet game with one or more packages of the consumer product, one or more packages of other consumer products, or one or more opportunities to play the Internet game.

3. The method of claim 1, further comprising steps of:
a. employing the Web browser program to allow the consumer to select another Internet-related activity other than the Internet game once the access to the Internet game is denied; and
b. rewarding the consumer according to the outcome of the Internet-related activity with one or more packages of the consumer product, one or more packages of other consumer products, or one or more opportunities to play the Internet game.

4. The method of claim 1, wherein the step of permitting access to the Web site further comprises the steps of:
a. determining if the format of the package identification number for a package containing the consumer product matches the predetermined format;
b. determining if the package identification number exists in the first database when the format of the package identification number for a package containing the consumer product matches the predetermined format;
c. determining if the package identification number exists in a second database when the package identification number exists in the first database;
d. permitting access to the Internet game by the at least one consumer if the package identification number does not exist in the second database; and
e. storing the package identification number in the database.

5. The method of claim 1, wherein the package identification number is generated by a random number generator.

6. The method of claim 5, wherein the format of the package identification number is a sequence of randomly arranged Arabic numerals.

7. The method of claim 5, wherein the length of the package identification number is no less than six (6) digits.

8. The method of claim 1, wherein the package identification number is printed on the package and accessible by the at least one consumer.

9. The method of claim 1, wherein the package identification number is printed on a printing medium that is associated with the package.

10. The method of claim 9, wherein the printing medium includes a sticker or a label.

11. The method of claim 1, wherein the consumer product is popcorn and the package containing popcorn is microwaveable.

12. The method of claim 1, further comprising a step of counting the number of accesses to the Web site for the consumer product from the cross-reference between the group of package identification numbers and the universal product code.

13. A method for consumer product promotion through the Internet, comprising:
a. providing a package containing a consumer product identified by a universal product code to a consumer;
b. establishing a package identification number having a format for the package;
c. employing a Web browser program to run a Web site that offers an Internet game; and
d. permitting access to the Internet game by the consumer to play the Internet game upon presentation of the package identification number over the Internet when the package identification number satisfies the following two conditions:
(i) the format of the package identification number matches a predetermined format; and
(ii) the package identification number has not been presented yet.

14. The method of claim 13, further comprising steps of:
a. employing the Web browser program to allow the consumer to interactively play the Internet game once the access is granted; and
b. rewarding the consumer according to the outcome of the Internet game with one or more packages of the consumer product, one or more packages of other consumer products, or one or more opportunities to lay the Internet game.

15. The method of claim 13, further comprising the step of denying access to the Internet game by the consumer to play the Internet game upon presentation of the package identification number over the Internet when the package identification number satisfies at least one of the following two conditions:
(i) the format of the package identification number is not in match with the predetermined format; and
(ii) the package identification number has been presented.

16. The method of claim 15, further comprising steps of:
a. employing the Web browser program to allow the consumer to select another Internet-related activity other than the Internet game once the access is denied; and
b. rewarding the consumer according to the outcome of the Internet-related activity with one or more packages of the consumer product, one or more packages of other consumer products, or one or more opportunities to play the Internet game.

17. The method of claim 13, wherein the step of permitting access to the Internet game further comprises the steps of:
a. determining if the format of the package identification number for a package containing the consumer product matches a predetermined format;
b. determining if the package identification number has been present in the database when the format of the package identification number for a package containing the consumer product matches the predetermined format;
c. permitting access to the Web site by the at least one consumer if the package identification number has not been present in the database; and
d. storing the package identification number in the database.

18. The method of claim 13, wherein the package identification number is generated by a random number generator.

19. The method of claim 18, wherein the format of the package identification number is a sequence of randomly arranged Arabic numerals.

20. The method of claim 18, wherein the length of the package identification number is no less than six (6) digits.

21. The method of claim 13, wherein the package identification number is printed on the package and accessible by the consumer.

22. The method of claim 13, wherein the package identification number is printed on a printing medium that is associated with the package.

23. The method of claim 22, wherein the printing medium includes a sticker or a label.

24. The method of claim 23, wherein the consumer product is popcorn and the package containing popcorn is microwaveable.

25. A system for consumer product promotion through the Internet, wherein the consumer product is identified by a universal product code and provided in a package to a consumer, comprising:
a. a number generator for establishing a package identification number having a format for the package;
b. a memory device; and
c. a processor coupled to the memory device and performing the following steps of:
(i) employing a Web browser program to run a Web site that offers an Internet game, wherein the Web site is electronically coupled to the memory device; and
(ii) permitting access to the Internet game by the consumer to play the Internet game upon presentation of the package identification number over the Internet when the package identification number satisfies the following two conditions:
(1) the format of the package identification number matches a predetermined format; and
(2) the package identification number has not been presented yet.

26. The system of claim 25, wherein the processor further performs the step of denying access to the Web site by the consumer to play the Internet game upon presentation of the package identification number over the Internet when the package identification number satisfies at least one of the following two conditions:
(1) the format of the package identification number is not in match with the predetermined format; and
(2) the package identification number has been presented.

27. The system of claim 25, wherein the processor further performs the steps of:
a. employing the Web browser program to allow the consumer to interactively play the Internet game once the access is granted; and
b. rewarding the consumer according to the outcome of the Internet game with one or more packages of the consumer product, one or more packages of other consumer products, or one or more opportunities to play the Internet game.

28. The system of claim 26, wherein the processor further performs the steps of:
a. employing the Web browser program to allow the consumer to select another Internet-related activity other than the Internet game once the access is denied; and
b. rewarding the consumer according to the outcome of the Internet-related activity with one or more packages of the consumer product, one or more packages of other consumer products, or one or more opportunities to play the Internet game.

29. The system of claim 25, wherein when performing the step of permitting access to the Web site, the processor further performs the steps of:
a. determining if the format of the package identification number for a package containing the consumer product matches the predetermined format;
b. determining if the package identification number has been present in a database resident in the memory device when the format of the package identification number for a package containing the consumer product matches the predetermined format;
c. permitting access to the Web site by the consumer if the package identification number has not been present in the database; and
d. storing the package identification number in the database.

30. The system of claim 25, wherein the number generator comprises a random number generator program resident in the memory device.

31. The system of claim 30, wherein the format of the package identification number is a sequence of randomly arranged Arabic numerals generated by the random number generator program.

32. The system of claim 31, wherein the length of the package identification number is no less than six (6) digits.

33. The system of claim 31, wherein the package identification number is printed on the package and accessible by the consumer.

34. The system of claim 31, wherein the package identification number is printed on a printing medium that is associated with the package.

35. The system of claim 34, wherein the printing medium includes a sticker or a label.

36. The system of claim 35, wherein the consumer product is popcorn and the package containing popcorn is microwaveable.

37. A computer program product in a computer readable medium of instructions, comprising:
a. instructions within the computer readable medium for running a Web site that offers an Internet game; and
b. instructions within the computer readable medium for permitting access to the Internet game by a user to play the Internet game upon presentation of a package identification number over the Internet when the package identification number satisfies the following two conditions:
(1) the format of the package identification number matches a predetermined format; and
(2) the package identification number has not been presented yet, wherein the package identification number is associated with a package containing a consumer product identified by a universal product code.

38. The computer program product of claim 37, further comprising instructions within the computer readable medium for denying access to the Internet game by the user to play the Internet game upon presentation of the package identification number over the Internet when the package identification number satisfies at least one of the following two conditions:
(i) the format of the package identification number is not in match with the predetermined format; and
(ii) the package identification number has been presented.

39. The computer program product of claim 38, further comprising:
a. instructions within the computer readable medium for allowing the user to select an Internet-related activity other than the Internet game once the access is denied; and
b. instructions within the computer readable medium for rewarding the user according to the outcome of the Internet related activity with one or more packages of the consumer product, one or more packages of other consumer products or one or more opportunities to play the Internet game.

40. The computer program product of claim 37, further comprising:
a. instructions within the computer readable medium for allowing the user to interactively play the Internet game once the access is granted; and
b. instructions within the computer readable medium for rewarding the user according to the outcome of the Internet game with one or more packages of the consumer product, one or more packages of other consumer products, or one or more opportunities to play the Internet game.
